(19) United States
(12) Patent Application Publication
(10) Pub. No.: US 2023/0091775 A1
(43) Pub. Date: Mar. 23, 2023

(54) DETERMINING LINEAGE INFORMATION FOR DATA RECORDS

(71) Applicant: salesforce.com, Inc., San Francisco, CA (US)

(72) Inventors: Ignacio Manzano, Buenos Aires (AR); Gustavo Battistoni, Buenos Aires (AR); Luis Contreras, Buenos Aires (AR); Ezequiel Block, Buenos Aires (AR); Daniel Fujii, Buenos Aires (AR); Rodrigo Pazos, Buenos Aires (AR); Tomas Fox, Buenos Aires (AR)

(73) Assignee: salesforce.com, Inc., San Francisco, CA (US)

(21) Appl. No.: 17/479,849

(22) Filed: Sep. 20, 2021

(51) Int. Cl. G06F 16/28; G06F 16/21

(52) U.S. Cl. CPC G06F 16/288; G06F 16/212

(57) ABSTRACT

A computer-based system may be configured to collect metadata for each source and target defined for a data pipeline and formatting information (e.g., schemas, transformations, etc.) associated with each entity and field. During the definition of the pipeline, how the data will end up in the target may be defined, for example, by a user of the computer-based system via a GUI/interface and/or the like. Information (e.g., modification information, etc.) describing how the data will end up in the target may be defined, stored, and accessed to determine and/or track over which fields and entities are affected by the user-defined mutations and over which schemas. Lineage information (e.g., a genealogical tree, data lineage tracing, etc.) describing a data, version, and transformation may be generated and used to determine a source for a data record, how changes to the data record are related, how lineage evolved, and/or the like.

### BACKGROUND

Integration platforms allow organizations to design, implement, and deploy software systems that harness heterogeneous resources (e.g., applications, services, and data sources) from across an organization's technical landscape. A data record may traverse a data pipeline, for example from a source to a target/destination of the integration platform may undergo various transformations and exchanges between complex and disparate systems/resources. Lineage information (e.g., data lineage, etc.) for the data record may include processes/executions affecting a data record, for example, such as a source/origin of the data record, what happens to the data record (e.g., extraction of the data record from a source, transformation of the data record, loading of the data record to a target/destination, etc.), and/or where the data record moves throughout the integration platform over time. Determining lineage information for a data record within an integration platform is a hard and manual task. For example, during replication of a data record through complex and disparate systems of the integration platform, it may be possible to determine where the data record came from, but since a data pipeline may be defined by various complex and disparate systems/resources information describing how the data record has been transformed may be non-existent. Open-source data analysis tools do not provide data lineage capabilities. To understand the data lineage of a data record, a user must write code based on the data available. However, since information describing how a data record has been transformed may be non-existent, it may be impossible to determine where which systems/resources processed the data record and/or how it has been transformed. Thus, troubleshooting issues related to the data record and/or determining diagnostics/metrics for the data record is challenging.

### BRIEF DESCRIPTION OF THE DRAWINGS

The accompanying drawings, which are incorporated herein and form a part of the specification, illustrate embodiments of the present disclosure and, together with the description, further serve to explain the principles of the disclosure and to enable a person skilled in the arts to make and use the embodiments.

FIG. 1 shows a block diagram of an example environment for determining lineage information for a data record, according to some embodiments.

FIG. 2 shows a block diagram of an example data bridge adapter, according to some embodiments.

FIG. 3 shows an example relational model, according to some example implementations.

FIG. 4 shows a block diagram of an example environment for determining lineage information for a data record, according to some embodiments.

FIGS. 5A-5C show examples of lineage information, according to some example implementations.

FIG. 6 shows an example of data quality information, according to some example implementations.

FIG. 7 shows an example of a method for determining lineage information for a data record, according to some embodiments.

FIG. 8 shows an example computer system, according to embodiments of the present disclosure.

The present disclosure will be described with reference to the accompanying drawings. In the drawings, like reference numbers indicate identical or functionally similar elements. Additionally, the left-most digit of a reference number identifies the drawing in which the reference number first appears.

### DETAILED DESCRIPTION

Provided herein are system, apparatus, device, method, computer program product embodiments, and/or combinations and sub-combinations thereof, for determining lineage information for data records. For example, the system, apparatus, device, method, computer program product embodiments, and/or combinations and sub-combinations thereof, may be used to determine, for a given data record, data indicative of what upstream sources and/or downstream assets are affected as the data record traverses a pipeline configured within the technical landscape and/or infrastructure of an organization, business, and/or operating entity, who/what are is generating the data, and who/what is relying on the data for decision making.

The technical landscape and/or infrastructure of an organization, business, and/or operating entity may incorporate a wide array of applications, services, data sources, servers, resources, and/or the like. Applications in the landscape/infrastructure may include custom-built applications, legacy applications, database applications, cloud-based applications, enterprise-resource-planning applications, and/or the like. The applications in the landscape and/or associated data may be configured with/on different devices (e.g., servers, etc.) at different locations (e.g., data centers, et.), and/or may be accessed via a network (e.g., cloud, Internet, wide-area network, etc.). Additionally, the organization, the business, and/or the operating entity may be in communication with and/or connect to a plurality of third-party systems, applications, services, and/or APIs to access data and incorporate additional functions into their technical landscape/infrastructure.

An integration platform may allow users to create useful business processes, applications, and other software tools that will be referred to herein as integration applications, integration scenarios, or integration flows. An integration flow may leverage and incorporate data from the organization's disparate systems, services, and applications and from third-party systems. An integration platform may bridge divides between these disparate technical resources by centralizing communications, using connectors that allow integration flows to authenticate and connect to external resources, databases, Software-as-a-service (SaaS) applications, and incorporate data and functionality from these external resources into an integration flow.

In some instances and/or use cases, an organization, business, and/or operating entity may use a data pipeline, such as an extract, transform, and load (ETL) pipeline, that aggregates data from disparate sources, transforms the aggregate data, and stores the data in a data warehouse, relational data store, and/or other destination for reporting, analysis, or other client-facing applications. As the data item travels it may be replicated and/or transformed to standardize it, or used in calculations to generate other data records that enrich an overall data environment. As data is replicated within the integration platform, it may be not possible to determine where the data came from or how the data has been transformed. If an organization, business, and/or operating entity does not know where their data comes from or goes, they have uncontrolled environments within which it is very difficult to extract value from data. If an organization, business, and/or operating entity cannot extract value from data, troubleshooting issues related to the data and/or producing useful diagnostic information (e.g., quality control and/or metric information, versioning information, etc.) for a data record is challenging. For example, to understand how a particular data record is processed (e.g., replicated, transformed, etc.) by the data pipeline and/or to determine the cause of a fault in the processing, a developer must create custom code to request data/information describing the processes (e.g. replication, aggregation, filtering, etc.) executed on the data record over time, which may become arduous.

In some instances and/or use cases, an organization, business, and/or operating entity may use data visualization tools (e.g., software, etc.) that allows developers to analyze separate and/or discrete components of data. However, these visualization tools do not enable developers to navigate the data lineage to determine the changes applied to data and the relationships of the data at the same time. For example, no visualization software enables the developer to see, for a particular entity, all the fields that are transferred to a target and how each transformation is applied over it, such as merge operations, custom operations, and/or the like. Again, a developer must create custom code to see, for a particular entity, all the fields that are transferred to a target and how each transformation is applied over it—which, if even possible, may become arduous.

In some instances and/or use cases, an organization, business, and/or operating entity may use data pipelines, such as extract, transform, and load (ETL) pipelines, that aggregate data from disparate sources, transforms the aggregate data, and stores the data in a data warehouse, relational data store, and/or other destination for reporting, analysis, or other client-facing applications. As data is exposed and/or processed through the pipelines, it may be subjected to disparate data quality qualifiers and/or metrics output by disparate APIs, systems, and/or the like. An organization, business, and/or operating entity is unable to effectively measure data quality based on disparate forms and/or values of metrics exposed from pipelines (e.g., ETL pipelines, etc.).

Accordingly, a need exists for systems and methods that provide a non-coding solution for determining detailed lineage information for data records within an integration platform. The methods and systems described herein define a complete data pipeline process, including each transformation and data schema involved during the process. Data and/or metrics may be determined/collected at each step of a data pipeline process, and the data and/or metrics may be used to determine, for each entity and field, the source/origin and how it was transformed based on which transformation was defined by each. Metrics collected may also be transformed to customer-facing metrics that allow an end-user to analyze the maturity and quality of data.

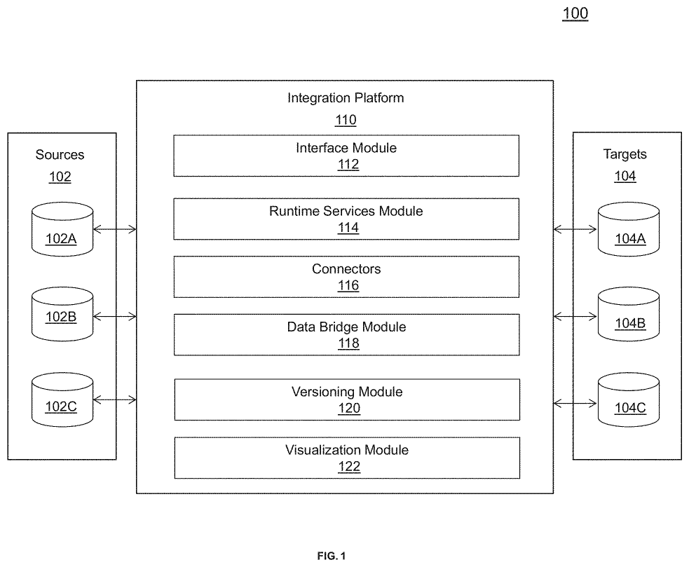

FIG. 1 shows a block diagram of an example environment 100 for determining lineage information for data records. The environment 100 may include data sources 102, data targets 104, and integration platform 110.

Data sources 102 (e.g., data source 102A, data source 102B, data source 102C, etc.) may include an application programming interface (API) and/or any other technical resource. Although only three data sources 102 (e.g., data source 102A, data source 102B, data source 102C, etc.) are shown in FIG. 1 for reference, the environment 100 may include any number of data sources 102. According to some embodiments, one or more of the data sources 102 may represent a plurality of APIs that the integration platform 110 may interact with to receive and update data. An API exposed by a data source 102 may adhere to any API architectural style, design methodologies, and/or protocols. For example, an API exposed by data sources 102 may include a Web-API such as a RESTful API or a SOAP API, a remote procedure call (RPC) API, a Java Database Connectivity (JDBC) API, a streaming API, and/or any other type of API.

According to some embodiments, one or more of the data sources 102 may be and/or include data storage mediums (e.g., data lakes, data silos, data buckets, virtual storage, remote storage, physical storage devices, relational databases, etc.) of any type/form and configured to store data in any form and/or representation, such as raw data, transformed data, replicated data, semi-structured data (CSV, logs, XML, etc.), unstructured data, binary data (images, audio, video, etc.), and/or the like.

According to some embodiments, one or more of the data sources 102 may be resources that are not APIs or storage mediums. For example, according to some embodiments, data sources 102 may include any appropriate data source that may be modeled using a dialect (e.g., a set of keywords and semantics that can be used to evaluate a schema, etc.).

Data targets 104 (e.g., data target 104A, data target 104B, data target 104C, etc.) may be any type of API, technical resource, and/or system to be included in an integration flow. Although only three data targets 104 (e.g., data target 104A, data target 104B, data target 104C, etc.) are shown in FIG. 1 for reference, the environment 100 may include any number of data targets 104. According to some embodiments, one or more of the targets 104 may represent APIs that adhere to any API architectural style, design methodologies, and/or protocols. For example, an API exposed by data targets 103 may include a Web-API such as a RESTful API or a SOAP API, a remote procedure call (RPC) API, a Java Database Connectivity (JDBC) API, a streaming API, and/or any other type of API.

Although the data sources 102 are shown in FIG. 1 as being separate and distinct from the data targets 103, according to some embodiments, there may be overlap between the sources and the targets. For example, a data source in one integration application may be a data target in a different integration application.

The integration platform 110 may be and/or include a system and/or software platform configured to access a plurality of software applications, services, and/or data sources. The integration platform 110 may be configured to design, maintain, and deploy integration flows based on the disparate software applications, services, and/or data sources. For example, the integration platform 110 may include/incorporate an enterprise service bus (ESB) architecture, a micro-service architecture, a service-oriented architecture (SOA), and/or the like. According to some embodiments, the integration platform 110 may allow a user to build and deploy integrations that communicate with and/or connect to third-party systems and provide additional functionalities that may be used to further integrate data from a plurality of organizational and/or cloud-based data sources. The integration platform 110 may allow users to build integration flows and/or APIs, and to design integration applications that access data, manipulate data, store data, and leverage data from disparate technical resources.

The integration platform 110 may include a design module 112, a runtime services module 114, connectors 116, a data bridge module 118, a versioning module 120, and data visualization module 122.

The interface module 112 may allow users to design and/or manage integration applications and integration flows that access disparate data sources 102 and data targets 104. The interface module 112 may standardize access to various data sources, provide connections to third-party systems and data, and provide additional functionalities to further integrate data from a plurality of organizational and/or cloud-based sources. The interface module 112 may include a graphical design environment and/or generate a graphical user interface (GUI) that enables a user to build, edit, deploy, monitor, and/or maintain integration applications. For example, the interface module 112 may include a GUI that may be used to define a complete data pipeline process, including each transformation and data schema involved during the process. During the definition of the pipeline, a user/developer may customize/personalize how data from a source (e.g., the data sources 102, etc.) will arrive and/or end up at a target (the data targets 104, etc.). Customizations and/or user preferences may be stored, for example, as a script for an expression language and/or programming language designed for transforming data, such as DataWeave and/or the like, and the entities and fields affected by the mutations for a given schema may be tracked.

The interface module 112 may communicate with a data visualization tool to cause display of visual lineage information for a data record detailing each transformation and/or the like of the data record from a data source 102 to a data target 104. As described later herein, once a pipeline has been defined, lineage information about the data (e.g., a genealogical tree, a data graph, etc.), version, and transformation may be stored, for example as metadata (and/or the like). The metadata may be associated with records/information produced/output when the pipeline runs. The lineage information may be stored and accessed at any time to determine how changes to a data record are related and how the lineage for the data record evolved.

The runtime services module 114 may include runtime components for building, assembling, compiling, and/or creating executable object code for specific integration scenarios at runtime. According to some embodiments, runtime components may create interpreted code to be parsed and applied upon execution. In some embodiments, runtime components may include a variety of intermediary hardware and/or software that runs and processes the output of integration flows. The runtime services module 114 may provide a point of contact between the data sources 102, the data targets 104, and the data bridge module 118. The runtime services module 114 may also include various system APIs.

The connectors 116 may provide connections between the integration platform and external resources, such as databases, APIs for software as a service (SaaS) applications, and many other endpoints. The connectors 116 may be APIs that are pre-built and selectable within the interface module 112, for example, using a drag-and-drop interface. The connectors 116 may provide reliable connectivity solutions to connect to a wide range of applications integrating with any other type of asset (e.g., Salesforce, Amazon S3, Mongo Db, Slack, JIRA, SAP, Workday, Kafka, etc.). The connectors 116 may enable connection to any type of API, for example, APIs such as SOAP APIs, REST APIs, Bulk APIs, Streaming APIs, and/or the like. The connectors 116 may facilitate the transfer of data from a source (e.g., the data sources 102, etc.) and a target (e.g., the data targets 104, etc.) by modeling the data into a file and/or the like, such as separated value files (CSV*, TSV, etc.), JavaScript Object Notation (JSON) text files delimited by new lines, JSON Arrays, and/or any other type of file. The connectors 116 may be responsible for and/or facilitate connecting to the data sources 102 and the data targets 104, authenticating, and performing raw operations to receive and insert data. The connectors 116 may support OAuth, Non-Blocking operations, stateless connection, low-level error handling, and reconnection.

The data bridge module 118 may be configured to receive/take data from a data source (e.g., the data sources 102, etc.) and replicate to a data target (e.g., the data targets 104, etc.), normalizing the data and schema (e.g., schema determined based on custom pipeline definitions, etc.). For example, the data bridge module 118 may support modeling of any API (and/or source otherwise capable of being modeled using a dialect) as an entity-relationship model. The data bridge module 118 may create and store a relational model based on raw data retrieved from a data source (e.g., the data sources 102, etc.) and translate received raw data to the relational data model. The data bridge module 118 may include software that translates data from a source (e.g., the data sources 102, etc.) into an entity-relationship model representation of the source model. The data bridge module 118 may also facilitate the use of data virtualization concepts to more readily interact with analytics and business intelligence applications, such as that described below with reference to data visualization tool 122. In this regard, the data bridge module 118 may create a relational model in a format that allows analytics and business intelligence tools to ingest/view the data.

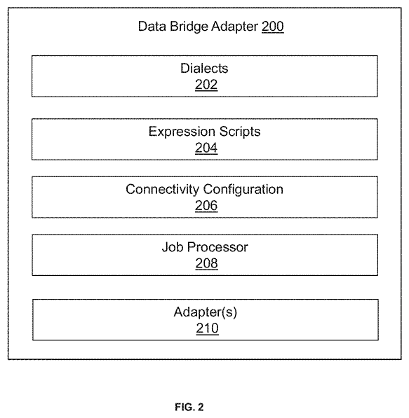

The data bridge module 118, for example, during a replication process, may apply deduplication, normalization, and validation to the derived relational model before sending the results to a target destination, which may be a data visualization tool or another data storage location. The data bridge module 118 may employ the connectors 116 to authenticate with and connect to a data source 102. The data bridge module 118 may then retrieve a model or unstructured data in response to an appropriate request. According to some embodiments, the data bridge module 118 may include a data bridge adapter 200 to move data from a data source in data sources 102 to a data target in data targets 104 while applying data and schema normalizations. FIG. 2 is a block diagram of components of the data bridge adapter 200.

As illustrated in FIG. 2, the data bridge adapter 200 may include dialects 202, expression scripts 204, connectivity configuration 206, job processor 208, and adapters 210.

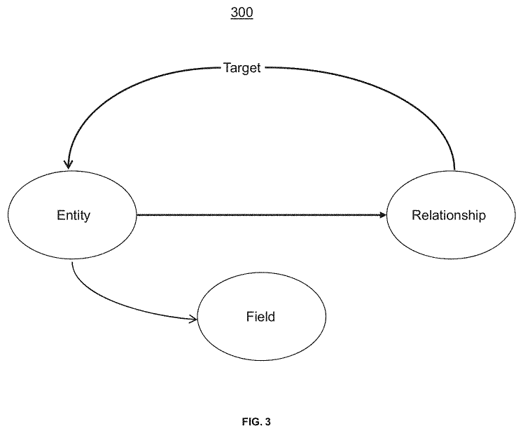

The data bridge adapter 200 may perform data virtualization by using definitions in a dialect file (described below as dialects 202) and an expression script (described below as expression scripts 204). With an appropriate dialect (e.g., a set of keywords and semantics that can be used to evaluate a schema, etc.) and an appropriate script selected based on the type of the data source, the data bridge adapter 200 may programmatically build an entity-relationship model of data received from a source (e.g., the data sources 102, etc.). FIG. 3 shows a directed acyclic graph (DAG) 300. The DAG 300 is an internal relational domain representation of the model of source/target determined by the data bridge adapter 200. A DAG representation such as DAG 300 enables the data bridge adapter 200 to easily know dependencies between entities and relationships. The DAG 300 represents an enriched model from a source's data model. The enriched model provides the information (e.g., metadata, etc.) needed to determine which field is a primary key and information (e.g., metadata, etc.) about the relationship between the entities. For example, a data source may be a WebAPI that defines a set of functions that can be performed and data that can be accessed using the HTTP protocol. In such an example, the data bridge adapter 200 may use a dialect that defines an entity-relationship diagram model representing the relational model of the WebAPI. With the WebAPI model defined in the dialect, the data bridge adapter 200 may use an expression script (e.g., a DataWeave script, etc.) to move the data from the API response to the corresponding WebAPI model. A resulting file may be a JSON file and/or the like. While the above example describes WebAPI, this is merely illustrative, and the technique may be readily extended to any source that may be modeled using a dialect. For example, the data source could be an Evented API that receives Kafka events or publisher/subscriber events. In this example, the data bridge adapter 200 may map and transform based on these protocols.

Returning to FIG. 2, according to some embodiments, the dialects 202 may be a metadata document that specifies a format/model of a particular API design methodology. Dialects of the dialects 202 may be created that represent relational models of various API design methodologies. For example, a dialect may be created that models WebAPI, a dialect may be created to model a Salesforce API, a dialect may be created to model a social media API, etc. The dialects 202 may be provided by the integration platform 110 as stock functionality for a finite list of APIs, and/or the dialects 202 may be extensible or customizable by particular customers to meet particular needs. According to some embodiments, the dialects 202 may be generated to model non-API data sources and anything that can be modeled using AML can conceivably be transformed into an entity-relationship mode by the data bridge adapter 200.

According to some embodiments, dialects of the dialects 202 may specify a format/model of a particular data pipeline configuration. As described, the dialects 202 may be written using AML definitions, and an AML processor tool can parse and validate the instances of the metadata document. For example, an example pipeline configuration dialect is as follows:

```
#%Dialect 1.0
dialect: Pipeline-Config
version: 1.0
documents:
      root:
          encodes: PipelineConfiguration
uses:
    core: file://vocabulary/core.yaml
    anypoint: file://vocabulary/anypoint.yaml
nodeMappings:
  PipelineConfiguration:
        classTerm:
        mapping:
          organizationId:
            propertyTerm: anypoint.organizationId
            range: string
            mandatory: true
          displayName:
            propertyTerm: core.name
            range: string
            mandatory: true
          name:
            propertyTerm: core.name
            range: string
            mandatory: true
          description:
            propertyTerm: core.description
            range: string
          version:
            range: string
            mandatory: true
          config:
            range: Configuration
            mandatory: true
          source:
            range: Source
            mandatory: true
          target:
            range: Target
            mandatory: true
          createById:
            propertyTerm: anypoint.userId
            range: string
            Mandatory: true
          createdAt:
            propertyTerm: core.dateCreated
            range: dateTime
            mandatory: true
          updatedAt:
            propertyTerm: core.dateModified
            range: dateTime
            mandatory: true
Configuration:
          classTerm:
          mapping:
            location:
              range: string
              mandatory: true
            frequency:
              range: integer
              mandatory: true
Source:
          classTerm:
          extends: Node
Target:
          classTerm:
          extends: Node
SchemaFilter:
          classTerm:
          mapping:
            entities:
              range: string #it should point to Connectivity config
              allowMultiple: true
              mandatory: false
Node:
          mapping:
            connection:
              range: link #it should point to Connectivity config
              mandatory: true
            connnection-schema: ?
            data-schema:
              range: link
              mandatory: true
            filter:
              range: SchemaFilter
```

The expression scripts 204 may be written in an expression language for accessing and transforming data. For example, the expression scripts 204 may be written in DataWeave expression language and/or the like. According to some embodiments, the expression scripts 204 may be written in any programming, expression, and/or scripting languages. The expression scripts 204 may parse and validate data received from a source according to a dialect in dialects 202. The outcome of this parsing may be, for example, a JSON document and/or the like that encodes a graph of information described in the dialect. As with dialects 202, a unique script may be created in expression scripts 204 for each API design methodology. Thus, an expression script may exist for WebAPI, one for Salesforce, etc. The expression scripts 204 may serve to transform the source model received from the API into the adapter model as defined by the associated dialect in dialects 202. The expression script may move the data from the responses received from the API to the entity-relationship model. According to some embodiments, the expression scripts 204 may be provided by integration platform 110 as stock functionality for a finite list of APIs and thus operate behind the scenes to perform the needed transformations. According to some embodiments, the expression scripts 204 may be extensible and/or customizable by particular customers to meet particular needs.

The connectivity configuration 206 may provide the services for handling the connections to various sources and targets (e.g., the data sources 102, the data targets 104, etc.) The connectivity configuration 206 may store login information, addresses, URLs, and other credentials for accessing the data sources 102 and/or the data targets 104. the connectivity configuration 206 may be employed by the data bridge adapter 200 to establish a connection and to maintain the connection itself, e.g., through connectors-as-a-service (CaaS) and/or the like.

The job processor 208 may perform additional transformations on an entity-relationship model derived from a data source (e.g., the data sources 102, etc.). The job processor 208 may perform configurations specified by a user in the interface when creating the entity-relationship model and/or standardized jobs needed based on the selected data target. The job processor 208 may transform and/or replicate a particular data field based on the unique requirements of the user or the target system. For example, the job processor 208 may modify the data as required for a particular data visualization tool's requirements. According to some embodiments, when a pipeline has been defined and is running, the job processor 208 may modify data (e.g., metadata, etc.) collected for a data record (e.g., each record with its input source(s) and which version of code processed it, etc.) to be used by the visualization module 122 to generate visual lineage information and/or tracing. The lineage information may be stored and/or used to determine how data mutations/changes are related and how the lineage evolved.

The adapters 210 may include information required to connect to various types of API and other data sources. For example, the adapters 210 may include components for connecting to APIs, via JDBC, stream adapters, file adapters, etc. Components needed for the adapters 210 may vary based on the type of adapter used.

Returning to FIG. 1., the versioning module 120 may support compatibility and versioning for the integration platform 110 and/or the data bridge module 118. The versioning module 120 may store versions of entity-relationship models when the data bridge module 118 generates an entity-relationship model from a data source. The versioning module 120 may store additional information in association with the models including a date, a version number, and other suitable information. According to some embodiments, each step in a transformation from source to target may be versioned independently, and the versioning module 120 can record each change to a schema separately. Thus, versioning system 120 may keep a history of the change and lineage of each record.

The visualization module 122 may be an analytics platform that allows data analysts to use advanced visualization techniques to explore and analyze data. For example, a user may use TABLEAU and/or a similar visualization tool to generate advanced visualizations, graphs, tables, charts, and/or the like. The visualization module 122 can output, for example, for an entity all the fields that are transferred to a target (e.g., the data targets 104, etc.) and how each transformation is applied, including merge operation and/or custom operations (e.g., determined by the associated dialect, etc.).

The visualization module 122 may be deployed locally (e.g., on a premises device, etc.), remotely (e.g., cloud-based, etc.), and/or within the integration platform 110. The visualization module 122 may have unique requirements for ingesting data. For example, according to some embodiments, the visualization module 122 may receive a JSON file and/or other representation of a relational model. According to some embodiments, the visualization module 122 may receive CSV data, PDF data, textual input, and/or any other type of input of data. The visualization module 122 may employ connectors (e.g., the connectors 116, etc.) specific to various data sources to ingest data.

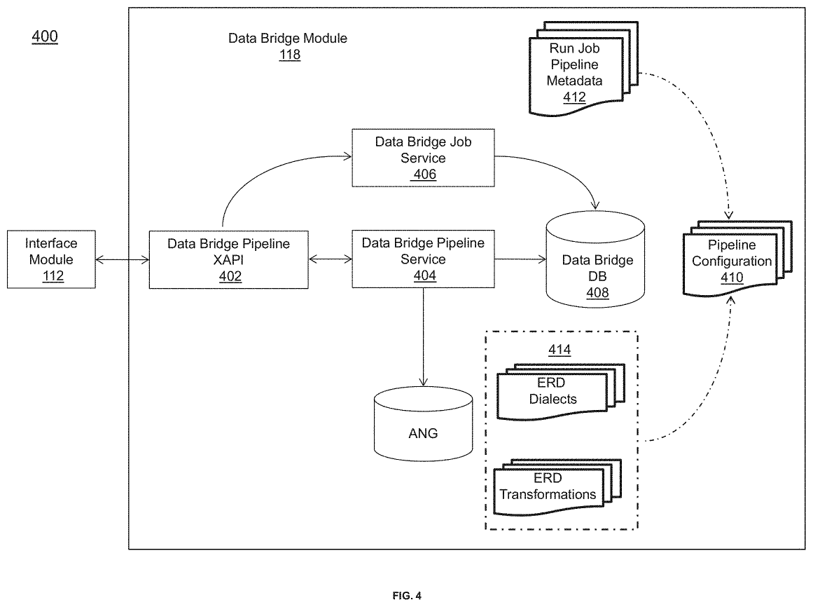

FIG. 4 shows a high-level diagram of a data bridge platform 400 facilitated by the data bridge module 118 to determine lineage information for a data record. The data bridge platform 400 may be configured to read/receive data from a data source (e.g., the data sources 102 of FIG. 1, etc.) and replicating the data into a data-target (e.g., the data targets 104 of FIG. 1, etc.) through a replication pipeline. The data bridge platform 400 may facilitate and/or support a plurality of data source types (e.g., Workday Type, Marketo Type, etc.). Each data source type of the plurality of data source types may be associated with a data source relational schema, and have data source instances. A data source relational schema may prove a relational model representation for data in data source type. Each data source relational schema may be used as the basis for defining multiple replication source schema. A data source instance may refer to an instance of a data source type, such as a specific Workday endpoint with a particular access credential. Each data source instance may be for a single data source type. Each Data Source Instance may be used as the source for many replication pipelines.

A replication pipeline defines a job of copying data from a data source instance into a data destination instance. Each replication pipeline may have a replication source schema that specifies the data subset from the data source instance to be copied. A replication pipeline may include configurations such as scheduling frequency, filtering, and validation. The replication pipeline is in charge of moving the data from data source instances to the data destination instance.

A replication source schema may be a selection of a subset of data source relational schema for a replication pipeline. Based on the replication source schema, the data bridge platform 400 may generate a corresponding data destination schema for a replication pipeline. The data destination schema may represent the relational model schema for the data destination type.

A destination instance may represent an instance of a data destination type, for example, such as a RedShift database with a particular access credential. Each data destination instance may be used as the destination for many replication pipelines. A data destination type may be a type of destination for data (e.g., Tableau Hyper Type, RDS Type, etc.). Each data destination type may have multiple data destination instances.

According to some embodiments, the interface module 112 in communication with a data bridge pipeline experience API (XAPI) 402 may define a data pipeline process, including each transformation and data schema involved during the process. The data bridge pipeline XAPI 402 may be a single point of accessing the data bridge platform 400 (e.g., the data bridge module 118, etc.) capabilities serving as both a proxy to redirect requests to the internal services of the data bridge platform and/or apply some level of orchestration when multiple requests are needed. During the definition of the data pipeline, the interface module 112 may receive and submit to the data bridge pipeline XAPI 402 user preference information that may be used to customize to personalize how the data will arrive and/or end up at a target (e.g., the data targets 104 of FIG. 1, etc.).

A data bridge pipeline service (DBPS) 404 may handle the create, read, update, and delete (CRUD) storage operations for pipelines and pipelines configurations. Pipeline configurations 410, such as user preference information that specify source and/or target/destination information, may be stored by the DBPS 404 in a data bridge database 408. The data bridge database 408 may be a relational database and/or suitable storage medium. The DBPS 404 may store lineage configurations 414, such as pre-defined and/or user preference information (e.g., dialects, schemas, etc.) that customizes/personalizes how data will arrive and/or end up at a target/destination (e.g., the data targets 104 of FIG. 1, etc.). Lineage configurations 414 may be stored, for example as JSON-LD data and/or the like, so that mutations that affect fields and entities for a given schema may be tracked. The Lineage configurations 414 may include entity-relationship diagrams (ERD) and/or models described as dialects (e.g., dialects 202 of FIG. 2, etc.) and ERD to data model transformation information that converts an ERD logical model to a data model target for a database type.

A data bridge pipeline job (DBJS) 406 may be responsible for triggering a pipeline and keeping track of the progress of a pipeline (e.g., each pipeline of the integration platform 110 of FIG. 1, etc.). The DBJS 406 may provide the capabilities to support the lifecycle of a pipeline (e.g., each pipeline of the integration platform 110 of FIG. 1, etc.). The pipeline life cycle describes the actions that can be applied to the pipeline. For example, actions that can be applied to the pipeline include an initial replication, an incremental update, and/or re-replication

As previously described herein, once a pipeline has been defined, for example, via the interface module 112 (e.g., a data bridge UI, etc.), the data bridge module 118 may collect information, such as Run job pipeline metadata 412, about the running pipeline and the result for each record processed. The run job pipeline metadata 412 may be linked to the pipeline configurations 410 (e.g., the pipeline defined, etc.) and the lineage information 414 (e.g., defined ERD and transformation, etc.). The combined information (e.g., metadata, etc.) may be used to generate a lineage traceability route from source to target over time and based on each schema version provided at the source and target.

The data bridge platform 400 supports multiple ways to retrieve the lineage information. For example, to retrieve lineage information for a data record, a user may interact with the interface module 112 (e.g., a GUI, etc.) to request the current lineage traceability for the latest pipeline from the DBPS 404. As another example, to retrieve lineage information for a data record, a user may submit a request, using an ANG Query, to determine the traceability of a field/entity based on their lineage and version history to compare lineage changes over time.

The data bridge platform 400, for example, based on lineage information/metadata and data generated by the DBJS 406, can trace/determine why a pipeline fails. The data bridge platform 400 can determine if a pipeline failure is related to some transformation, and if so, over which entity and field.

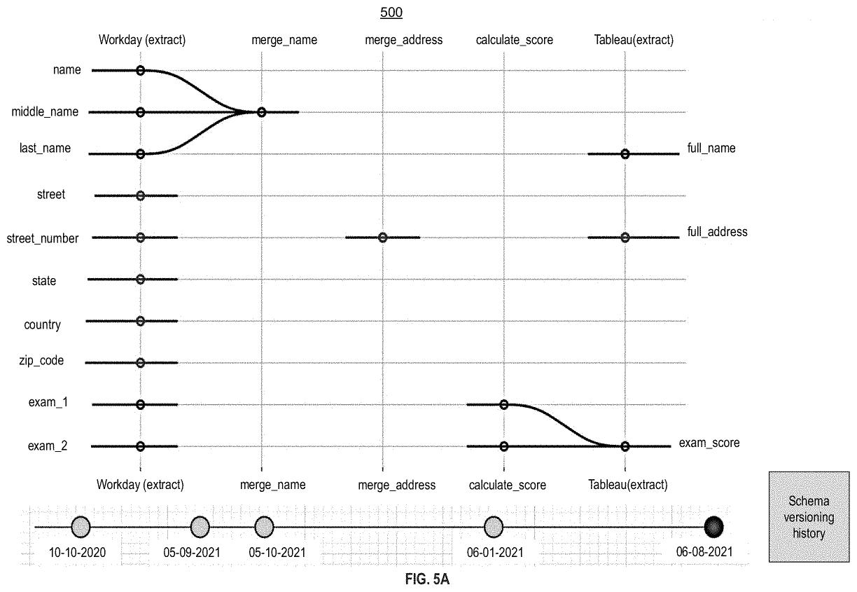

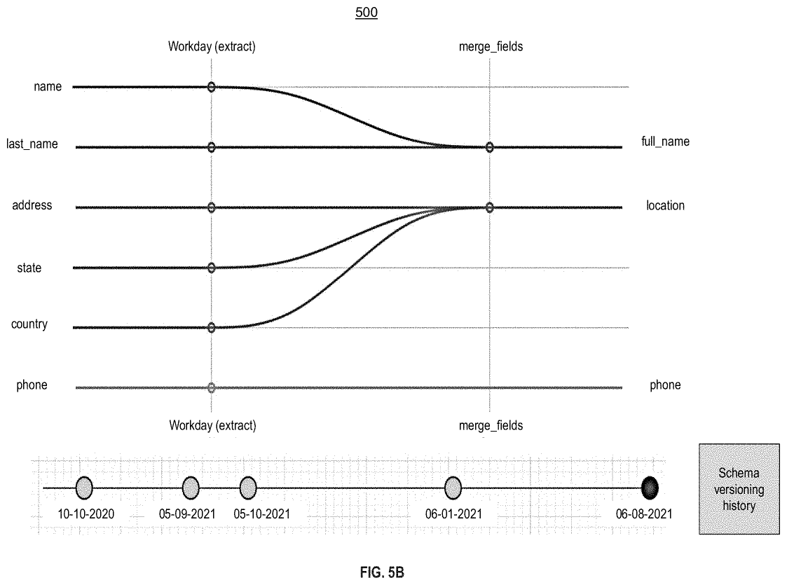

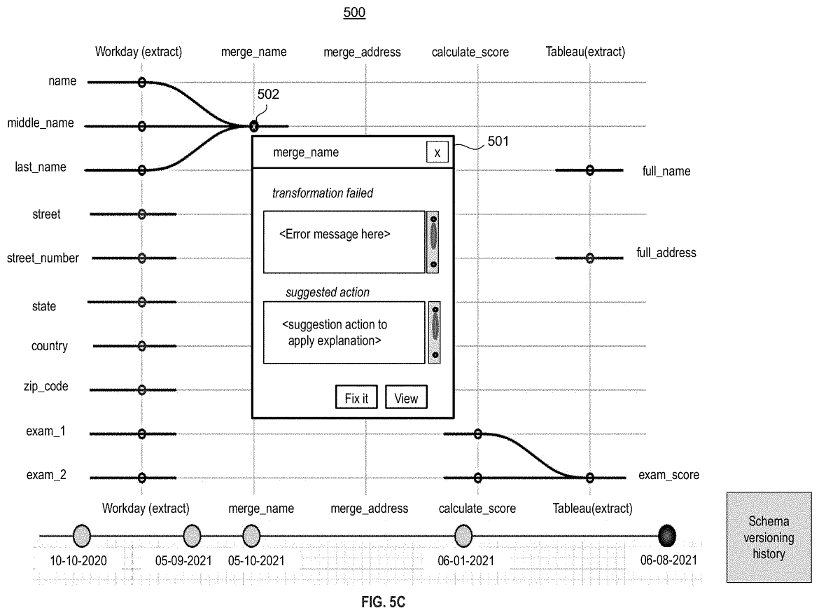

Returning to FIG. 1, the visualization module 122 may be configured to enable a user/developer to see and understand what data lineage is for a data record. The visualization module 122 enables a user/developer to see, for an entity, all the fields that are transferred to a target and how each transformation is applied, including merge operations and/or custom operations. The visualization module 122 may include a visualization tool, for example, such as TABLEAU and/or the like, that allows data lineage to be explored and analyzed. FIGS. 5A-5C show example data lineage from a Workday Report to TABLEAU where some fields have been merged. As shown in FIG. 5A, the visualization module 122 may cause display graphical lineage information 500 that depicts which fields are going to be transferred from a source to a target, which transformations are going to be applied, when the transformations will be applied, how the transformations will be applied, and/or which fields are going to be produced at the target. For example, as shown FIG. 5A, the fields {name}, {middle name}, and {last name} are transformed by a merge operation on May 10, 2021 to a single field {full name} at the target. The visualization module 122 can display how schema changes over time.

As shown in FIG. 5B, when a user/developer interacts with (e.g., a click over via a mouse and/or an interactive tool, etc.) the lineage line, the whole path can be tagged/marked. As shown in FIG. 5C, the user/developer can interact with (e.g., click via a mouse and/or an interactive tool, etc.) each point to cause display of a popup dialog 501 that includes contextual information about a transformation name, a script used, a version of transformation, an operational result (e.g., success/fail, etc.), and/or the like. In event of a pipeline failure that prevents a transformation from being applied, the graphical lineage information 500 may support troubleshooting by displaying the path of the failure. For example, the interactive element 502 shows where in the pipeline a fault (e.g., a transformation failure, etc.) occurs. Identifying where a fault occurs in the pipeline can help explain how schema evolves (e.g., schema history changes, etc.).

Returning to FIG. 1, according to some embodiments, the data bridge module 118 may be configured to collect disparate metric information for a running pipeline (e.g., all the metrics exposed from ETL pipelines, etc.) and use the disparate metric information in a computation process of which the output may be used to measure data quality by transforming the disparate metric information into a single group of that allow the maturity and quality of data to be analyzed. For example, based on schemas defined for each pipeline (e.g., the dialects 202 of FIG. 2, AML Dialect, etc.) and customizable validation rules, the data bridge module 118 can categorize and calculate key performance indicators (KPI) for the data, per pipeline and entity giving, and output data quality information without having to code.

For example, as the data bridge module 118 applies deduplication, normalization, and/or validation to data (e.g., relational models) the data bridge module 118 may apply one or more algorithms to the results to produces information about the quality and freshness of data. For example, the data bridge module 118 may collect data duplication (nro records), new data (nro records), updated data (new records), errors (record not allowed to insert or update), data freshness measures, and/or the like. The data bridge module 118 may collect any type of metric information, and the metric information collected may be agnostic of a data source and/or source technology. The data bridge module 118 may scale its metric information collection and analysis according to anything that may be modeled using a dialect (e.g., the dialects 202, etc.).

The data bridge module 118, for example, when applying deduplication, normalization, and/or validation to data (e.g., relational models), may apply one or more of the following algorithms to the results to produce custom qualifying information regarding data freshness, data duplication, new data, updated data, errors, and/or the like:

$$freshness = \frac{volume of data}{time of transfer} \qquad 1.$$

$$Data Duplication = \frac{Nro Record Duplicated}{Total Records} \qquad 2.$$

$$New Data Ratio = \frac{Nro New Records}{Total Records} \qquad 3.$$

$$Updated Data Ratio = \frac{Nro Updated Records}{Total Records} \qquad 4.$$

$$Errors = \frac{( Nro Records Failed + Nro Records Failed To Create )}{Total Records} \qquad 5.$$

$$** All values are expressed between 0 - 1 , \\ except Freshness which is measured in time$$

The data bridge module 118 may use relational models (ERD models) based on dialects (e.g., AML Dialects, the dialects 202, etc.) transformed to JSON-LD and/or the like to determine data quality. For example, using an AML Dialect (Sematic) and the linked data representation of the data, the data bridge module 118 may determine/match which entities/fields are changed, updated, and/or deleted. The data bridge module 118 may use the custom qualifying information to define data integrity rules (error detection). For example, the data bridge module 118 may be configured with a model checker such as AML Model checker and/or the like to identify data accuracy and completeness. Based on a defined relational model (ERD model), the data bridge module 118 can identify the primary key and duplicate records. With an understanding of the primary key and duplicate records, the data bridge module 118 may generate KPI information for the data being processed. The KPI information may be stored in a data quality repository to produce insight and/or generate alarms regarding data quality, for example, for each entity. KPI information stored in the data quality repository can be used, for example, by the data bridge module 118 to determine, for each entity, the quality of a data warehouse and produce changes in an associated model, rules, data ingestion, and/or the like to facilitate any improvements needed.

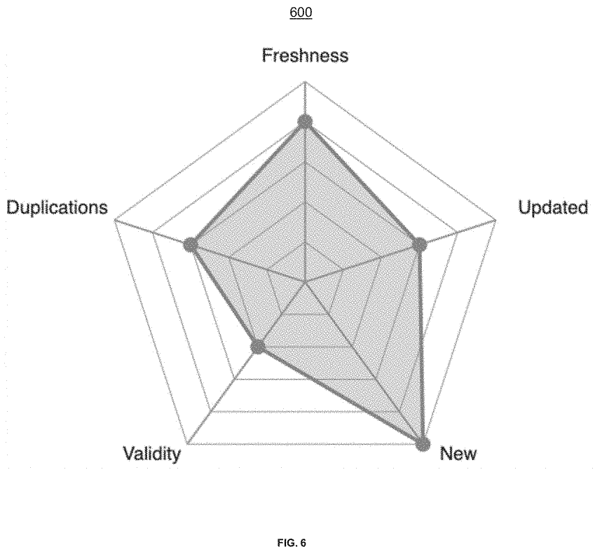

The data bridge module 118 may communicate with the visualization module 122 to output a visual display of data quality. Data quality metrics can be displayed in any way to show different insights for the same metrics. For example, a histogram can be used to show how data quality evolves, where an x-axis represents time and a y-axis represents a data quality metric. According to some embodiments, the data bridge module 118 may communicate with the visualization module 122 to display data quality and freshness metrics in a radar chart 600 as shown in FIG. 6. The radar chart 600 shows primary dimensions used to determine/calculate data quality for an entity and can be used to compare the quality of the entity through time. Rules used to determine data quality may be customized (e.g., via AML Custom Validations, etc.) and data quality may be categorized in any manner (e.g., bronze, silver, gold, etc.).

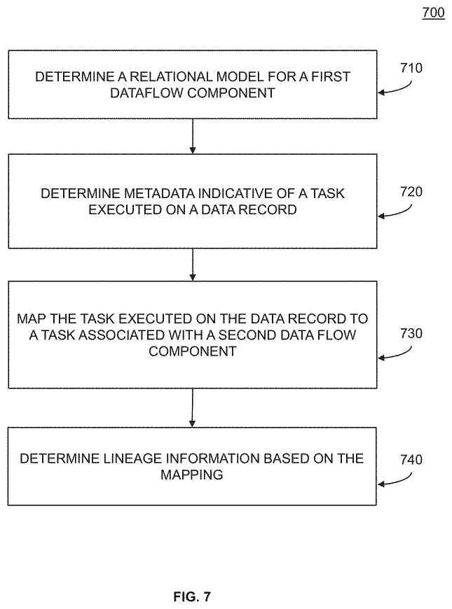

FIG. 7 shows a flowchart of an example method 700 for determining lineage information for a data record, according to some embodiments. Lineage information may be determined without parsing source code and/or the like. A computer-based system may be configured to collect metadata for each source and target defined for a data pipeline and formatting information (e.g., schemas, transformations, etc.) associated with each entity and field. During the definition of the pipeline, how the data will end up in the target may be defined, for example, by a user of the computer-based system via a GUI/interface and/or the like. Information (e.g., modification information, etc.) describing how the data will end up in the target may be defined, stored, and accessed to determine and/or track over which fields and entities are affected by the user-defined mutations and over which schemas.

Lineage information (e.g., a genealogical tree, data lineage tracing, etc.) describing a data, version, and transformation may be stored, for example, as metadata related to the data record traversing the data pipeline. The lineage information may be stored and/or accessed. For example, the lineage information may be used to determine a source for a data record, how changes to the data record are related, how lineage evolved, and/or the like.

Method 700 may be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art(s).

In 710, a computer-based system (e.g., the integration platform 110 comprising the data bridge module 118, etc. may determine a relational model for a first dataflow component of the data flow components. For example, the computer-based system may determine the relational model for the first dataflow component based on formatting information that defines data flow components for the data pipeline and a task for each of the data flow components. The formatting information may include a user-defined schema and/or transformations for each dataflow component of the data pipeline. The relational model indicates an entity-field relationship for the first dataflow component, for example, indicating other dataflow components of the data pipeline.

In 720, the computer-based system may determine, based on a data record traversing the data pipeline, metadata indicative of a task executed on the data record.

In 730, the computer-based system may map the task executed on the data record to a task associated with a second dataflow component of the data pipeline. For example, the computer-based system may map the task executed on the data record to the task associated with the second dataflow component of the data pipeline based on the relational model for the first dataflow component and/or a value of the data record. For example, mapping the task executed on the data record to the task associated with the second dataflow component of the data pipeline may include determining, based on an entity-field relationship indicated by the relational model, at least the second dataflow component and a third dataflow component of the data pipeline. After determining at least the second dataflow component and the third dataflow component of the data pipeline, the computer-based system may determine that the task executed on the data record corresponds to the task associated with the second dataflow component. For example, determining that the task executed on the data record corresponds to the task associated with the second dataflow component may be based on the value of the data record. The value of the data record may be a type of value caused by the task associated with the second dataflow component.

In 740, the computer-based system may determine lineage information for the data record. For example, the based on the mapping the task executed on the data record to the task associated with the second dataflow component. According to some embodiments, method 700 may further include causing display of the data lineage information. According to some embodiments, method 700 may further include determining, based on another data record traversing the data pipeline, a change to the relational model for the first dataflow component. Based on the change to the relational model for the first dataflow component, the computer-based system may, for example, determine an update (e.g., version information, etc.) to the formatting information.

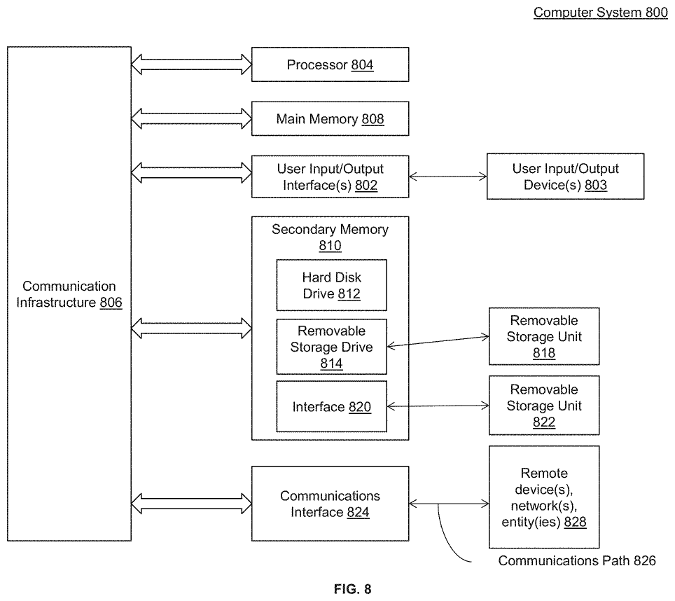

In the above description, numerous specific details such as resource partition FIG. 8 is an example computer system useful for implementing various embodiments. Various embodiments may be implemented, for example, using one or more well-known computer systems, such as computer system 800 shown in FIG. 8. One or more computer systems 800 may be used, for example, to implement any of the embodiments discussed herein, as well as combinations and sub-combinations thereof.

Computer system 800 may include one or more processors (also called central processing units, or CPUs), such as a processor 804. Processor 804 may be connected to a communication infrastructure or bus 806.

Computer system 800 may also include user input/output device(s) 802, such as monitors, keyboards, pointing devices, etc., which may communicate with communication infrastructure or bus 806 through user input/output device(s) 802.

One or more of processors 804 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 800 may also include a main or primary memory 808, such as random access memory (RAM). Main memory 808 may include one or more levels of cache. Main memory 808 may have stored therein control logic (i.e., computer software) and/or data.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, a tape backup device, and/or any other storage device/drive.

Removable storage drive 814 may interact with a removable storage unit 818. The removable storage unit 818 may include a computer-usable or readable storage device having stored thereon computer software (control logic) and/or data. Removable storage unit 818 may be a floppy disk, magnetic tape, compact disk, DVD, optical storage disk, and/any other computer data storage device. Removable storage drive 814 may read from and/or write to the removable storage unit 818.

Secondary memory 810 may include other means, devices, components, instrumentalities, and/or other approaches for allowing computer programs and/or other instructions and/or data to be accessed by computer system 800. Such means, devices, components, instrumentalities, and/or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 800 may further include a communication or network interface 824. Communication interface 824 may enable computer system 800 to communicate and interact with any combination of external devices, external networks, external entities, etc. (individually and collectively referenced by reference number 828). For example, communication interface 824 may allow computer system 800 to communicate with external or remote devices 828 over communications path 826, which may be wired and/or wireless (or a combination thereof), and which may include any combination of LANs, WANs, the Internet, etc. Control logic and/or data may be transmitted to and from computer system 800 via communication path 826.

Computer system 800 may also be any of a personal digital assistant (PDA), desktop workstation, laptop or notebook computer, netbook, tablet, smartphone, smartwatch or other wearables, appliance, part of the Internet-of-Things, and/or embedded system, to name a few non-limiting examples, or any combination thereof.

Computer system 800 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 800 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats, and/or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 800, main memory 808, secondary memory 810, and removable storage units 818 and 822, as well as tangible articles of manufacture embodying any combination of the foregoing. Such control logic, when executed by one or more data processing devices (such as computer system 800), may cause such data processing devices to operate as described herein.

Based on the teachings contained in this disclosure, it will be apparent to persons skilled in the relevant art(s) how to make and use embodiments of this disclosure using data processing devices, computer systems, and/or computer architectures other than that shown in FIG. 8. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

Additionally and/or alternatively, while this disclosure describes exemplary embodiments for exemplary fields and applications, it should be understood that the disclosure is not limited thereto. Other embodiments and modifications thereto are possible and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Implementation One or more parts of the above implementations may include software. Software is a general term whose meaning of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

1. A method comprising:
determining, based on formatting information that defines data flow components for a data pipeline and a task for each of the data flow components, a relational model for a first dataflow component of the data flow components;
determining, based on a data record traversing the data pipeline, metadata indicative of a task executed on the data record;
mapping, based on the relational model for the first dataflow component, the task executed on the data record, and a value of the data record, the task executed on the data record to an error for a task associated with a second dataflow component of the data pipeline; and
outputting, based on the mapping between the task executed on the data record and the error for to the task associated with the second dataflow component, lineage information for the data record.

2. The method of claim 1, wherein the formatting information comprises a user-defined schema for each dataflow component of the data pipeline.

3. The method of claim 1, wherein the relational model indicates an entity-field relationship for the first dataflow component.

4. The method of claim 1, wherein the mapping the task executed on the data record to the error for the task associated with the second dataflow component of the data pipeline comprises:
determining, based on an entity-field relationship indicated by the relational model, at least the second dataflow component;
determining, based on the task executed on the data record, a target value type of the data record; and
determining, based on the target value type of the data record being different from a type of the value of the data record, the error.

5. The method of claim 1, wherein the metadata indicates an affect on at least one of an entity indicated by the relational model or a field of the data record based on the task executed on the data record.

6. The method of claim 1, wherein the outputting the lineage information further comprises causing display of the lineage information.

7. The method of claim 1, further comprising:
determining, based on another data record traversing the data pipeline, a change to the relational model for the first dataflow component; and
determining, based on the change to the relational model, an update to the formatting information.

8. A system comprising:
a memory; and
at least one processor coupled to the memory and configured to perform operations comprising:
determining, based on formatting information that defines data flow components for a data pipeline and a task for each of the data flow components, a relational model for a first dataflow component of the data flow components;
determining, based on a data record traversing the data pipeline, metadata indicative of a task executed on the data record;
mapping, based on the relational model for the first dataflow component, the task executed on the data record, and a value of the data record, the task executed on the data record to an error for a task associated with a second dataflow component of the data pipeline; and
outputting, based on the mapping between the task executed on the data record and the error for to the task associated with the second dataflow component, lineage information for the data record.

9. The system of claim 8, wherein the formatting information comprises a user-defined schema for each dataflow component of the data pipeline.

10. The system of claim 8, wherein the relational model indicates an entity-field relationship for the first dataflow component.

11. The system of claim 8, wherein the mapping the task executed on the data record to the error for the task associated with the second dataflow component of the data pipeline comprises:
determining, based on an entity-field relationship indicated by the relational model, the second dataflow component;
determining, based on the task executed on the data record, a target value type of the data record; and
determining, based on the target value type of the data record being different from a type of the value of the data record, the error.

12. The system of claim 8, wherein the metadata indicates an affect on at least one of an entity indicated by the relational model or a field of the data record based on the task executed on the data record.

13. The system of claim 8, wherein the outputting the lineage information further comprises the causing display of the lineage information.

14. The system of claim 8, the operations further comprising:
determining, based on another data record traversing the data pipeline, a change to the relational model for the first dataflow component; and
determining, based on the change to the relational model, an update to the formatting information.

15. A non-transitory computer-readable medium having instructions stored thereon that, when executed by at least one computing device, causes the at least one computing device to perform operations comprising:
determining, based on formatting information that defines data flow components for a data pipeline and a task for each of the data flow components, a relational model for a first dataflow component of the data flow components;
determining, based on a data record traversing the data pipeline, metadata indicative of a task executed on the data record;
determining, based on the relational model for the first dataflow component, the task executed on the data record, and a value of the data record, an error for a task associated with a second dataflow component of the data pipeline; and
determining, based on a mapping between the task executed on the data record and the error for the task associated with the second dataflow component, lineage information for the data record.

16. The non-transitory computer-readable medium of claim 15, wherein the formatting information comprises a user-defined schema for each dataflow component of the data pipeline.

17. The non-transitory computer-readable medium of claim 15, wherein the relational model indicates an entity-field relationship for the first dataflow component.

18. The non-transitory computer-readable medium of claim 15, wherein the mapping the task executed on the data record to the error for the task associated with the second dataflow component of the data pipeline comprises:
determining, based on an entity-field relationship indicated by the relational model, the second dataflow component;
determining, based on the task executed on the data record, a target value type of the data record; and
determining, based on the target value type of the data record being different from a type of the value of the data record, the error.

19. The non-transitory computer-readable medium of claim 15, wherein the metadata indicates an affect on at least one of an entity indicated by the relational model or a field of the data record based on the task executed on the data record.

20. The non-transitory computer-readable medium of claim 15, wherein the outputting the lineage information, the further comprises causing display of the lineage information.
